(19) United States
(12) Patent Application Publication
(10) Pub. No.: US 2005/0037748 A1
(43) Pub. Date: Feb. 17, 2005

(54) Measuring terminal, service device and request terminal

(75) Inventor: Hideki Sawano, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/784,182

(22) Filed: Feb. 24, 2004

(30) Foreign Application Priority Data
Aug. 11, 2003 (JP) 2003-207212

(51) Int. Cl. H04Q 7/20

(52) U.S. Cl. 455/423

(57) ABSTRACT

In the case of searching for a search object 400, measuring terminals 300 obtain information about an area where the search is effected from a request terminal 100 requesting the search, and a service device 200 calculates the position information of the search object 400 for the terminal 100 on the basis of present position information and distance information given from the measuring terminals 300.

### BACKGROUND OF THE PRESENT INVENTION

The present invention relates to a technology for a position search by mobile terminals having a wireless communication function.

Generally, a common carrier, which conducts cellular phone services, provides users with a service for searching for a position of a building, etc. by use of a wireless communication function of a cellular phone. In this position search service, the position of a search object is specified by transmitting and receiving radio waves between a plurality of radio wave relay stations and the search object. In this case, the search object has a wireless communication function for communicating with the plurality of radio wave relay stations.

Note that a technology (Japanese Patent Application Laid-Open Publication No.2002-32392) of providing position information of a user of a mobile terminal is disclosed as a technology related to the position search using the mobile terminals.

It is noted that, in the conventional position search technology, when it is discriminated a positional relationship between the search object and a searcher, if the search object is a building or the like shown on a map, then, the searcher specified a position of the searcher self by utilizing a GPS (Global Positioning System) function provided in the mobile terminal, and collating the position of the searcher with the map. Thereby, the searcher is able to specify a distance and a direction between the search object and the searcher.

In the position search technology using the mobile terminals including the conventional GPS function, however, it was difficult to measure a relative positional relationship between the search object and the searcher if where the search object is a moving object and an object (e.g., a vending machine, etc.) shown on the map.

Further, even if the position information about the search object can be acquired beforehand in the mobile terminal including no GPS function, the position information of the terminal itself can not be acquired. Accordingly, this technology was difficult to search for the position.

Moreover, the prior technology does not take it into account either to search for position information of a comparatively small search object such as a vending machine, etc. that is not shown on the map or of a moving search object.

### SUMMARY OF THE PRESENT INVENTION

The present invention was made in view of the items given above and aims at a solution thereof. The present invention provides a technology to obtaining position information of a search object having a difficultly with respect to a position search based on map information, and to providing the position information of the search object to a terminal that is hard to acquire present position information.

The present invention adopts the following means in order to accomplish the object.

Namely, the present invention is a measuring terminal cooperating with a service device for providing position information to a request terminal requesting a position of a search object, wherein a search request for searching the position of the search object from the request terminal is accepted, radio waves receivable by the search object are transmitted, a response to the radio waves is received from the search object, a distance between the measuring terminal and the search object is calculated from the received response, present position information of this measuring terminal is acquired, and the present position information and the distance information are transmitted to the service device.

The measuring terminal of the present invention measures the position of the search object in response to the request given from the terminal having no present position acquisition function. Hence, according to the measuring terminal of the present invention, it is possible to provide the position information of the search object to the terminal that is hard to acquire the present position information.

Further, in the measuring terminal of the present invention, the search request may contain information capable of specifying the request terminal, and the present position information and the distance information may be transmitted together with the specifiable information to the service device.

In the measuring device of the present invention, the request terminal having transmitted the search request is specified, and the position information of the search object is provided through the service device to the request terminal. Therefore, according to the measuring terminal of the present invention, it is feasible to surely provide the position information of the search object to the terminal that is hard to acquire the present position information.

Moreover, the present invention is a service device for providing position information to a request terminal requesting the position information of a search object, wherein present position information of the measuring terminal and information about a distance between the measuring terminal making the measurement and the search object, is received from a measuring terminal for measuring a position of the search object, and the position information of the search object that has been calculated based on the present position information and the information about the distance to the search object, is transmitted to the request terminal.

In the service device of the present invention, the position information of the search object that has been requested by the request terminal, is calculated from the present position information of the terminal and the information about the distance to the search object, which has been measured by the measuring terminals to provided the position information. Hence, according to the service device of the present invention, it is possible to provide the position information of the search object that meets the request.

Still further, the present invention, a request terminal provided with position information of a search object through a system including a service device for providing the position information of the search object and measuring terminals for reporting distances to the search object to the service device, wherein a search request for the position information of the search object is transmitted to the measuring terminals existing in the periphery of the self-terminal, and the position information of the search object that is based on the reports given from the measuring terminals, is received via the service device.

In the request terminal of the present invention, the terminal having no present position acquisition function requests other terminals having the present position acquisition function to measure the position information of the search object. Therefore, according to the request terminal of the present invention, even the terminal, which does not include the present position acquisition function, is capable of surely acquiring the position information of the search object existing in the periphery of the terminal itself.

Moreover, in the request terminal of the present invention, the search request may contain information capable of specifying the individual request terminal and information for designating the search object, and the position information may be received in accordance with the specifiable information.

In the request terminal of the present invention, the information specifying the request terminal having sent the search request is transmitted to the measuring terminals, and the position information of the search object is provided based on the specifying information. Hence, according to the request terminal of the present invention, even the terminal that is hard to acquire the present position information by the terminal itself, can be surely provided with the position information of the search object.

Note that the present invention may also be program for having a function of any one of the above devices actualized. Furthermore, in the present invention, this program may be recorded on a storage medium readable by a computer.

### BRIEF DESCRIPTION OF THE DRAWINGS

FIG. 1 is a view showing an outline of how a position search system according to an embodiment of the present invention is carried out.

FIG. 2 is a function block diagram showing an outline of a request-side mobile terminal according to the position search system.

FIG. 3 is a function block diagram showing an outline of a base station according to the position search system.

FIG. 4 is a function block diagram showing an outline of a measuring-side mobile terminal according to the position search system.

FIG. 5 is a function block diagram showing an outline of a vending machine according to the position search system.

FIG. 6 shows one example of a mail for notifying of the position information of the vending machine, which is transmitted to the request-side mobile terminal.

FIG. 7 shows one example of a mail if where a search object for transmission to a request-side mobile terminal, is not discovered.

FIG. 8 is a processing flowchart of a request-side mobile terminal according to the position search system.

FIG. 9 is a processing flowchart of a base station according to the position search system.

FIG. 10 is a processing flowchart of a measuring-side mobile terminal according to the position search system.

FIG. 11 is a processing flowchart of one example of a response process to radio waves for measuring position information of a vending machine in the position search system.

FIG. 12 is a flowchart when the request-side mobile terminal sets a search object range for the measuring-side mobile terminals in the position search system.

### DESCRIPTION OF THE PREFERRED EMBODEMENTS

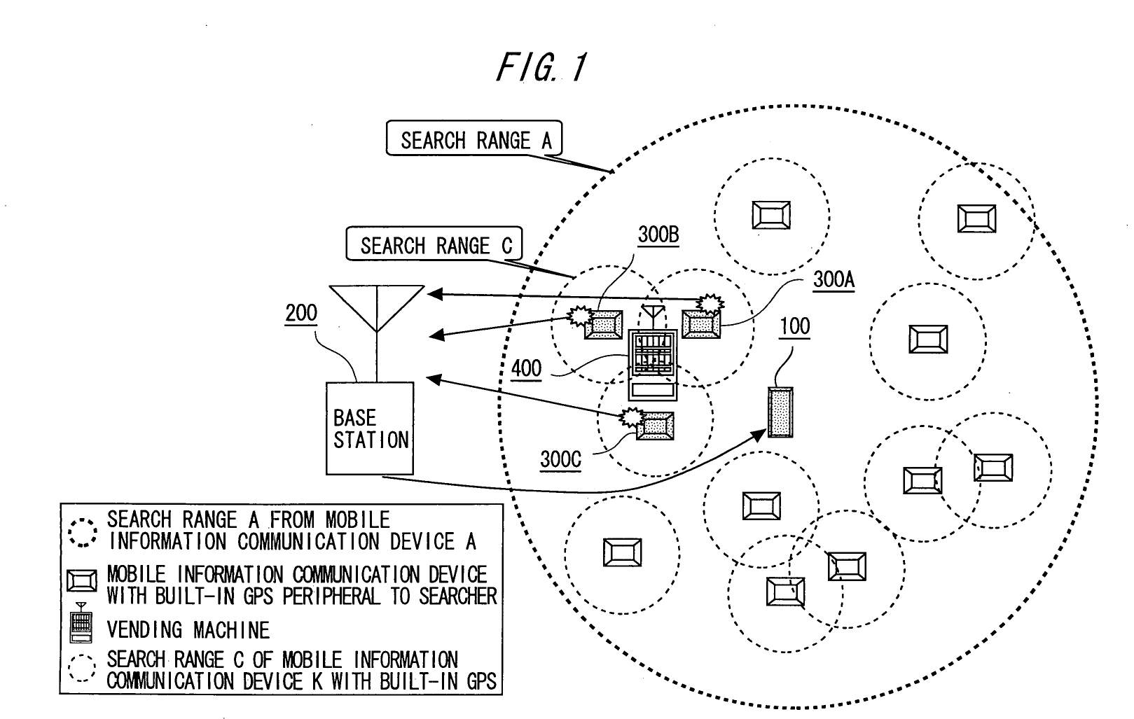

A position search system according to a preferred embodiment of a measuring terminal, a service device and a request terminal of the present invention, will be described based on drawings in FIGS. 1 through 10. In the embodiment, the position search system in the embodiment, which is configured by the measuring terminal, the service device and the request terminal of the present invention, searches for position information of a vending machine including a wireless communication function to provide the position information to a mobile terminal that requests the search for a position of this vending machine.

<Outline of Position Search System>

An outline of the position search system in the embodiment will be explained. The position search system constructed of the measuring terminal, the service device and the request terminal of the present invention includes, as its components, the request terminal requesting the search for a position of a search object, the service device that searches for the position of the search object in response to the search request from this request terminal, and the measuring terminal that measures position information of the search object in response to the search request from this service terminal.

FIG. 1 is a view showing an outline of how the position search system is embodied. In FIG. 1, the position search system in the embodiment includes a request-side mobile terminal 100 serving as the request terminal of the present invention, a base station 200 serving as the service device of the present invention, measuring-side mobile terminals 300 serving as the measuring terminals of the present invention, and a vending machine 400 as the search object of the present invention. Note that measuring-side mobile terminals 300A, 300B and 300C are generically termed the measuring-side mobile terminals 300 in the embodiment.

The request-side mobile terminal 100 determines a search range A in which its own position is centered, as a search range where the terminal 100 requests the position information of a desired vending machine 400.

Further, the measuring-side mobile terminals 300 for measuring the position information of the vending machine 400, transmit radio waves to the vending machine 400 that meets the request within its own search range C. Then, the measuring-side mobile terminals 300 receive the radio waves from the vending machine 400, acquire its own position information through a GPS function and transmit the position information to the base station 200.

The base station 200 obtains, from a plurality of measuring-side mobile terminals 300, pieces of present position information of the respective measuring-side mobile terminals 300 and distance information to the vending machine 400. Then, the base station 200 calculates pieces of information (such as a latitude, a longitude, etc.) indicating geographical positions from the request-side mobile terminal 100 to the vending machine 400 on the basis of the present position information and the distance information to the vending machine 400, which have been obtained from the plurality of measuring-side mobile terminals 300. Moreover, the base station 200 provides the request-side mobile terminal 100 with the position information of this vending machine 400.

<Outline of Components>

Next, an outline of the components related to the position search system will be explained.

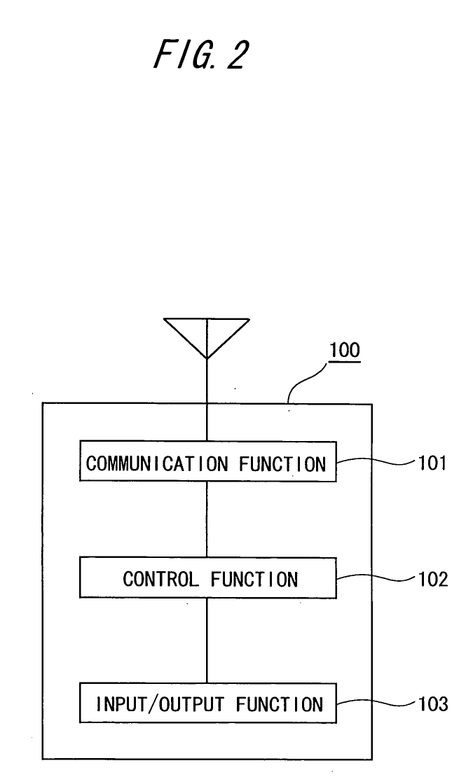

FIG. 2 is a function block diagram showing an outline of the request-side mobile terminal 100 related to the position search system. The request-side mobile terminal 100 is constructed by use of a computer such as a cellular phone or a PDA (Personal Digital (Data) Assistant), etc. in order to execute processes according to the present invention. This request-side mobile terminal 100 includes, as pieces of hardware unillustrated, a processing device (constructed of a CPU, a main memory device (RAM), etc.), an input/output unit and so on), a communication device (such as an antenna, a transmitter/receiver, etc.), an input device (a push button, a dial, a keyboard, a microphone, etc.), an output device (a liquid crystal display device, an electro-luminescence panel (EL panel), a loudspeaker, etc.) and a secondary storage device (a flash memory, etc.). Then, the request-side mobile terminal 100 actualizes a communication function 101, a control function 102 and an input/output function 103 as functions for executing the processes of the request terminal according to the position search system.

The communication function 101, for searching for a position of the search object, communicates with the base station 200 and the measuring-side mobile terminals 300 through the communication device. Further, the communication function 101 includes a function by which the request-side mobile terminal 100 as a normal cellular phone communicates with other phones through the communication device. Moreover, the communication function 101 includes a wireless communication function of transmitting, without via the base station 200, search request information to the measuring-side mobile terminals 300 in the position search system.

This wireless communication function can be configured by sharing some portions of the communication device as the cellular phone, e.g., some portions of the antenna and a circuit of the transmitter/receiver. In this case, for instance, a frequency band opened to the public as in a transceiver may be used as carrier waves. Further, the wireless communication function may involve using, separately from the cellular phone, wireless LAN, or communication devices on Bluetooth, etc. Moreover, the wireless communication function may utilize a terminal-to-terminal communication function in a PHS (Personal Handy Phone) telephone service.

The processing device executes a program thereby actualizing the control function 102. The control function 102 makes the request-side mobile terminal 100 function as the search request terminal of the present invention. This control function 102 transmits information about a category of the search object and about the search range to the measuring-side mobile terminals 300 in the range concerned through the communication function 101. Furthermore, the control function 102 executes a process for making the request-side mobile terminal 100 actualizes a function as the normal cellular phone.

The input/output function 103 accepts, from a user, character information or voice information such as the information on the search object and the information on the search range through the input device. Moreover, the input/output function 103 outputs, to the user, image information or voice information such as the position information of the search object through the output device.

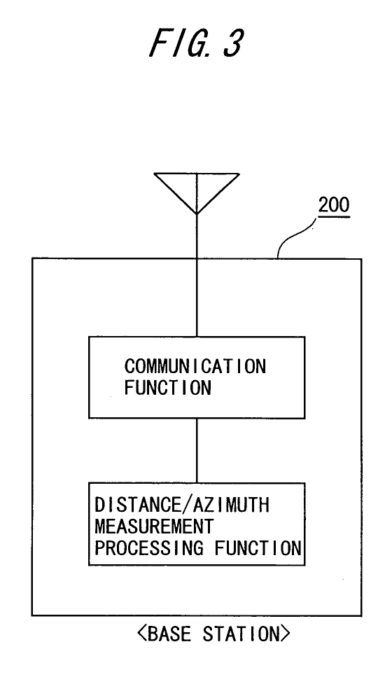

FIG. 3 is a function block diagram showing an outline of the base station 200 according to the position search system. The base station 200 is, for executing the processes according to the present invention, constructed by use of a computer such as a personal computer (PC), a workstation (WS), a dedicated server machine, etc. in addition to the function as the base station for the normal cellular phone service. This base station 200 includes, as pieces of hardware unillustrated, a processing device (constructed of a CPU, a main memory device (RAM), etc.), an input/output unit, OS, a device driver and so on), an input device (a keyboard, a microphone, etc.), an output device (a liquid crystal display device, a loudspeaker, etc.) and a secondary storage device (a hard disk, etc.). Then, the base station 200 actualizes a communication function 201, a control function 102 and a distance/azimuth measurement processing function 202 as functions for executing the processes of the service device according to the position search system.

The communication function 201, for searching for a position of the search object, communicates with the request-side mobile terminal 100 and the measuring-side mobile terminals 300. Further, the communication function 201 includes a function as the base station for the normal cellular phone service.

The distance/azimuth measurement processing function 202 calculates, based on the present position information of the measuring-side mobile terminals 300 and the distance information to the vending machine 400, the position information such as the latitude/longitude information of the vending machine 400.

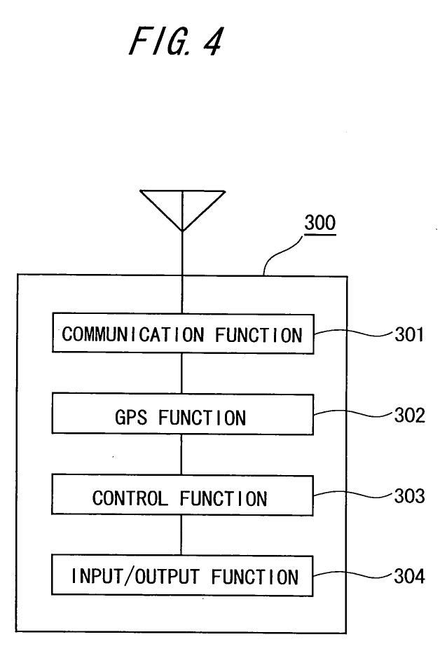

FIG. 4 is a function block diagram showing an outline of the measuring-side mobile terminal 300 according to the position search system. The measuring-side mobile terminal 300 is, for executing the processes according to the present invention, constructed by use of a computer such as a cellular phone or a PDA (Personal Digital (Data) Assistant), etc . . . . This measuring-side mobile terminal 300 includes, as pieces of hardware unillustrated, a processing device (constructed of a CPU, a main memory device (RAM), etc.), an input/output unit, a device driver and so on), a communication device (such as an antenna, a transmitter/receiver, etc.), a position information acquisition device (such as a GPS device, etc.), an input device (a keyboard, a microphone, etc.), an output device (a liquid crystal display device, a loudspeaker, etc.) and a secondary storage device (a flash memory, etc.). Then, the measuring-side mobile terminal 300 actualizes a communication function 301, a GPS function 302, a control function 303 and an input/output function 304 as functions for executing the processes of the measuring terminal according to the position search system.

The communication function 301, for searching the position of the search object in response to a request from the request-side mobile terminal 100, communicates with the base station 200 and the request-side mobile terminal 100. Furthermore, the communication function 301 includes a function by which the measuring-side mobile terminal 300 as a normal cellular phone communicates with other telephones through the communication device.

The GPS function 302 calculates present positions of the measuring-side mobile terminals 300 by receiving the radio waves transmitted from a plurality of low-orbit satellites orbiting around the earth.

The processing device executes a program, thereby actualizing the control function 303. The control function 303 makes the measuring-side mobile terminal 300 actualize a function as the measuring terminal of the present invention. This control function 303 transmits the radio waves for measuring the position information to the vending machine 400 serving as the search object trough the communication function 301 on the basis of a category of the search object and the information about the search range, which have been received from the request-side mobile terminal 100. Moreover, the control function 303 executes the process by which the measuring-side mobile terminal 300 actualizes the function as the normal cellular phone.

The input/output function 304 accepts the character information or the voice information related to the normal cellular phone service through the input device. Further, the input/output function 304 outputs to the user the image information or the voice information related to the normal cellular phone service through the output device.

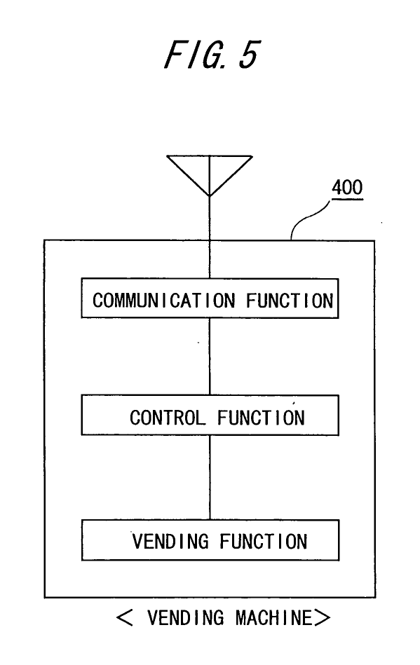

FIG. 5 is a function block diagram showing an outline of the vending machine 400 according to the position search system. The vending machine 400 is, for executing the processes according to the present invention, constructed of a variety of computers in addition to the architecture as the normal vending machine. This vending machine 400 includes, as pieces of hardware unillustrated, a processing device (constructed of a CPU, a main memory device (RAM), etc.), an input/output unit, OS, a device driver and so on), a communication device (an antenna, a transmitter/receiver, etc.) and a secondary storage device (a flash memory, etc.). Note that there might be a case where the architecture of the processing device does not include the OS. Then, the vending machine 400 actualizes a communication function 401, a control function 402 and a vending function 403 as functions for actualizing the processes for the search object according to the position search system.

The communication function 401, for searching the position of the search object, communicates with the base station 200 and the measuring-side mobile terminals 300 through the communication device. A communication system at this time may be the terminal-to-terminal communication of the PHS phones, wherein the mobile terminals communicate directly with each other without via the base station 200, or such that the mobile terminals are made to function as the so-called transceivers. Further, the communication system at this time may involve using any types of communication systems such as the wireless LAN, Bluetooth and so forth.

The control function 402 actualizes a function as the search object by the processing device executing a program. This control function 402 transmits the radio waves for the measuring the position information, which have been transmitted from the measuring-side mobile terminals 300, to the measuring-side mobile terminals 300 as transmitting sources through the communication function 101.

The vending function 403 is a function needed for the vending machine 400 to operate as a normal vending machine, such as supplying commercial articles, or dealing with money.

<Example of. Position Search by the Position Search System>

Next, one example of the position search by the position search system will be explained with reference to FIG. 1. FIG. 1 shows one example in which the position information from the request-side mobile terminal 100 to the vending machine 400, is provided by the base station 200 and the measuring-side mobile terminals 300.

To start with, the request-side mobile terminal 100 establishes the information of the search object and the information of the search range as a search request in response to a request from the user. At this time, for example, the search object in pieces of search request information is set as a cigarette vending machine. Further, the search range A in the pieces of search request information is set to a range of 50 mm from a radius 40 in which the request-side mobile terminal 100 is centered.

The request-side mobile terminal 100 transmits the search request information to the plurality of measuring-side mobile terminals 300 existing within the search range A. This search range A is, under transmission power control of the communication function 401, set in a range of being transmissible on electromagnetic waves. Moreover, the request-side mobile terminal 100 transmits, in addition to the search request information, information (ID) capable of specifying the request-side mobile terminal 100 to the plurality of measuring-side mobile terminals 300. Herein, the ID is, for example, one of a unique number assigned beforehand by the base station 200 when the request-side mobile terminal 100 utilizes the position search system, a number generated based on a manufacturing serial number of the request-side mobile terminal 100 when the request-side mobile terminal 100 utilizes the position search system, a number generated previously by the user and assured to be unique by the base station 200 when the request-side mobile terminal 100 utilizes the position search system, and so on. Then, a mail address of the mail used in case a result of the search object is sent to the request-side mobile terminal 100, is determined based on this unique ID.

The plurality of measuring-side mobile terminals 300 existing within the search range A receives the search request information containing the ID from the request-side mobile terminal 100. Namely, the terminal capable of receiving the electromagnetic waves carrying the search request functions as the measuring-side mobile terminal 300. Then, the measuring-side mobile terminal 300 transmits, in response to this piece of search request information, the radio waves for measuring the position information to the vending machine 400. At this time, in the position information measuring radio waves to be transmitted, a transmitting frequency and a response code are changed depending on the search object, for instance, a type of the vending machine and so on. With this change, only the search object corresponding thereto responds to the radio waves for measuring the position information.

The vending machine 400 having received the radio waves for measuring the position information transmits the response radio waves to the measuring-side mobile terminal 300.

The measuring-side mobile terminal 300 having received the response radio waves from the vending machine 400 calculates, based on delay times of the response radio waves, distances from the measuring-side mobile terminals 300 to the vending machine 400.

After establishing the distance to the vending machine 400, the measuring-side mobile terminals 300A, 300B, 300C acquire pieces of information about their present positions through the GPS function 302. Then, the measuring-side mobile terminals 300A, 300B, 300C send pieces of information about the distances to the vending machine 400 and about their present positions to the base station 200.

The base station 200 calculates, based on the information about the distances to the vending machine 400 and about the present positions of the measuring-side mobile terminals 300, the position information of the vending machine 400 as viewed from the request-side mobile terminal 100.

In FIG. 1, the measuring-side mobile terminals 300, which could receive the response radio waves from the vending machine 400, are three terminals 300A, 300B, and 300C. A position of the vending machine 400 is determined by solving an equation of three circles with the above distances serving as their radii, wherein the positions of these three measuring-side mobile terminals 300A, 300B, and 300C are centered. Namely, the position information (the latitude/longitude) of the vending machine is obtained from a point of intersections of the three circles.

After calculating the position information of the vending machine 400, the base station 200 sends this piece of information to the request-side mobile terminal 100. At this time, the base station 200 transmits image information generated by attaching the position of the vending machine 400 to the character information or the map information by mail. Further, the base station 200, if the search target corresponding thereto is not discovered, also sends this purport by mail to the request-side mobile terminal 100.

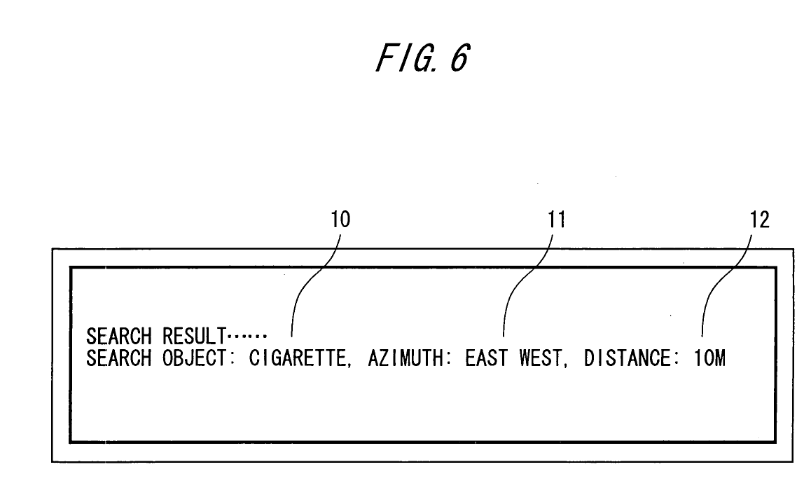

FIG. 6 is one example of the mail for notifying of the position information of the vending machine 400, which is transmitted to the request-side mobile terminal 100. At this time, the mail has indications of a search object (the vending machine 400) 10 requested by the user, an azimuth 11 of the search object as viewed from a target object in the vicinity of the vending machine 400 and a distance 12 to the search object as viewed from the target object serving as a basis in the vicinity of the vending machine 400. At this time the target object serving as the basis may be preset in an area (cell) range managed by the base station 200. For example, an intersection, a building serving as a conspicuous mark, a station, etc., may be employed. The azimuth 11 and the distance 12 may be obtained from the position information of the vending machine 400, which have been calculated based on these positions (the latitude/longitude).

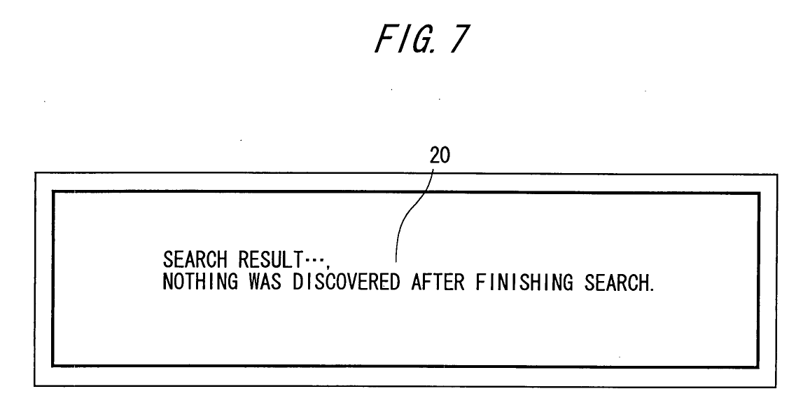

FIG. 7 is one example of the mail if where there is not discovered the search object for the transmission to the request-side mobile terminal 100. At this time, the mail has an indication of a message 20 purporting that the search object was not discovered.

<Processing Flowchart of Each Component>

Next, a processing flowchart of each of the components in the position search system will be described. Note that the explanations overlapped with those in the example of the position search by the position search system, are omitted in the following description.

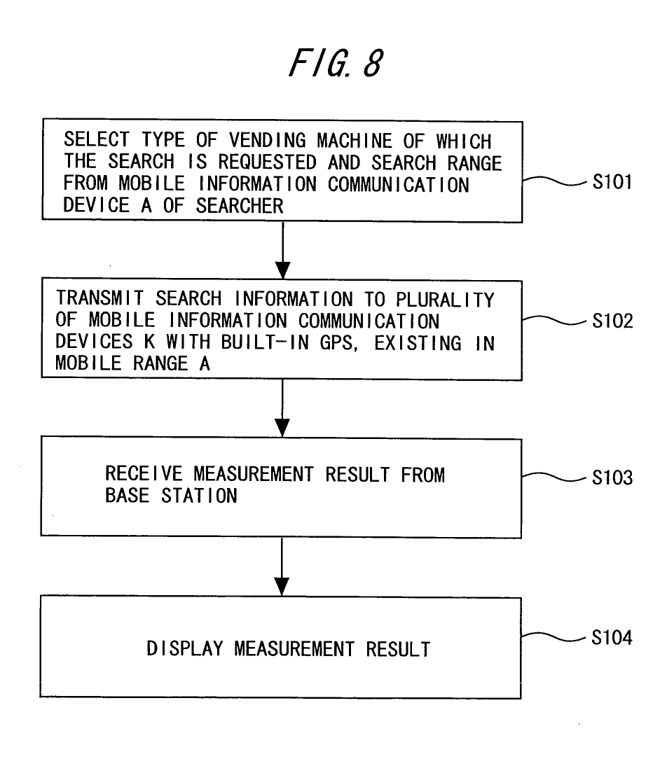

FIG. 8 is a processing flowchart of the request-side mobile terminal 100 according to the position search system.

To begin with, the request-side mobile terminal 100 selects a type of the vending machine in which the search is requested, and a search range A from the request-side mobile terminal 100 of a user (a searcher). Then, the information on this type and the search range A is set as the search request information (step 101 in FIG. 8, which will hereinafter be abbreviated such as S101).

The request-side mobile terminal 100 transmits the search request information to the measuring-side mobile terminals 300 including the GPS function within the search range A (S102).

In the base station 200 and the measuring-side mobile terminals 300, after establishing the position information of the vending machine 400, the request-side mobile terminal 100 receives, from the base station 200 by mail, a measurement result containing the position information of this vending machine 400 (S103). Then, the request-side mobile terminal 100 displays the mail of the measurement result received (S104).

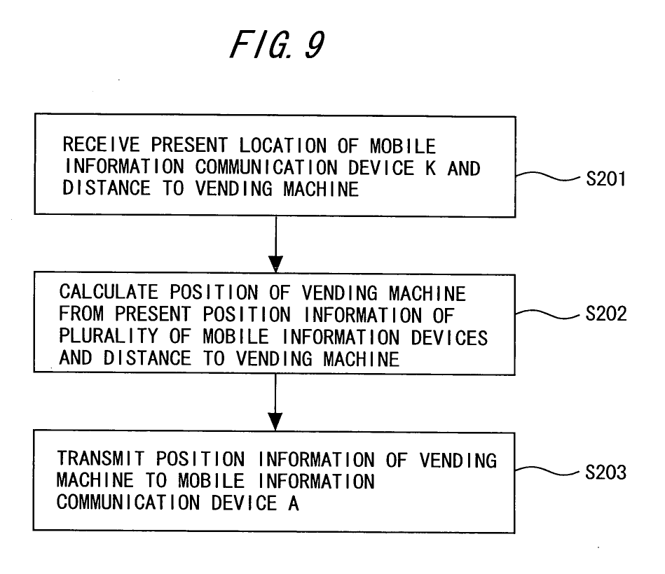

FIG. 9 is a processing flowchart of the base station 200 according to the position search system.

To start with, the base station 200 receives the information about the distances to the vending machine 400 and about the present positions of the measuring-side mobile terminal 300 from the measuring-side mobile terminals 300 (step 201 in FIG. 9, which will hereinafter be abbreviated such as S201).

The base station 200 calculates the position information (latitude/longitude) of the vending machine 400 on the basis of the pieces of information about the distances and the present positions, which have been received from the plurality of measuring-side mobile terminal 300. Moreover, the base station 200 calculates, in an easy-to-understand manner to the user of the request-side mobile terminal 100, the position information (for instance, 100 meters to the West from an intersection 00, or 50 meters from an xx building towards the station, etc.) of the vending machine 400 as viewed from the target object in the vicinity of the vending machine 400 (S202). Then, the base station 200 transmits, to the request-side mobile terminal 100, the position information of the vending machine 400 as viewed from this request-side mobile terminal 100 (S203).

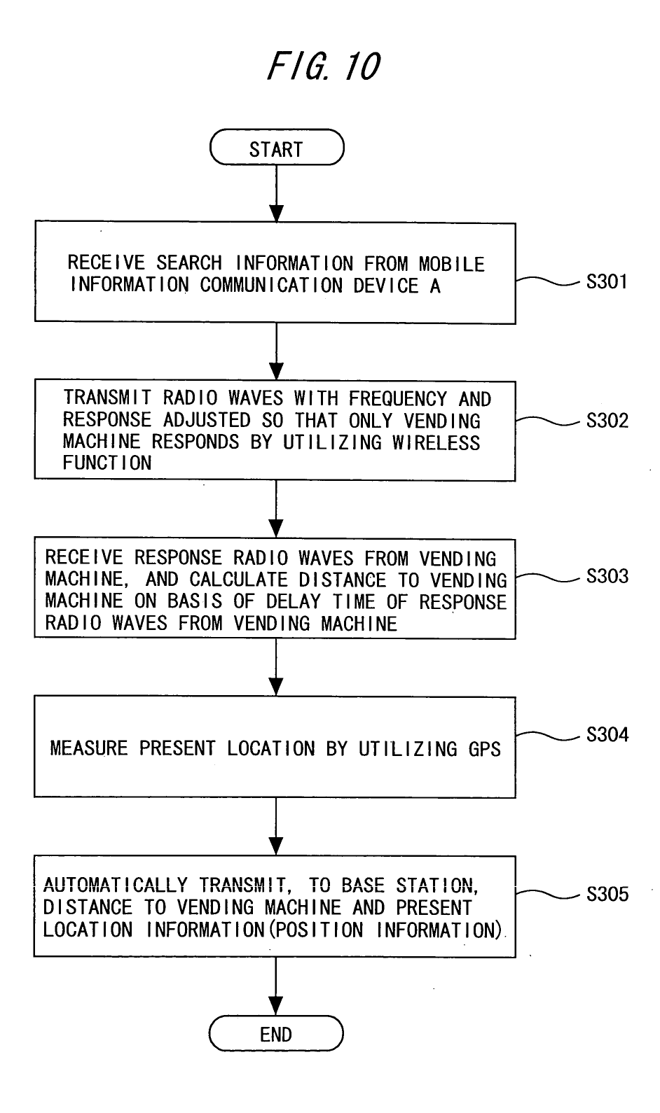

FIG. 10 is a processing flowchart of the measuring-side mobile terminal 300 according to the position search system.

At first, the measuring-side mobile terminal 300 receives the search request information from the request-side mobile terminal 100 (step 301 in FIG. 10, which will hereinafter be abbreviated such as S301).

The measuring-side mobile terminal 300 transmits the position information measuring radio waves (response radio waves) responded only by the search object (the vending machine 400) corresponding to the search request information (S302). Then, the measuring-side mobile terminal 300 receives the response radio waves from the vending machine 400 corresponding thereto, and calculates the distances to the vending machine 400 from the measuring-side mobile terminals 300 on the basis of delay times of the response radio waves (S303).

After calculating the distances, the measuring-side mobile terminal 300 acquires the present position information by utilizing the GPS function (S304). Then, the measuring-side mobile terminals 300 transmit the distances to the vending machine 400 and the present position information to the base station 200 (S305).

<Effects of the Embodiment>

The following effects are acquired by actualizing the position search system according to the embodiment.

According to the position search system in the embodiment, even if where the mobile terminal has no function of obtaining the present position information, it is possible to obtain the information about the distance and the azimuth of the desired search object.

Further, according to the position search system in the embodiment, with respect to even the search object having no position information on the map, the information about the distance and the azimuth from the search request terminal can be acquired.

### MODIFIED EXAMPLES

In the embodiment, the measuring terminal, the service device and the request terminal of the present invention have been described by way of one example of being applied mainly to the vending machine, however, the present invention is not limited to this application and can be widely embodied with respect to the position search system for other search objects.

Moreover, the position search system transmits by mail the search result of the search object to the request-side mobile terminal. However, the position search system, for example, may also notify the user of address information of a Web page for display the search result of the search object to make the user browse the Web page.

Further, the position search system provides the search result of the search object in character information to the request-side mobile terminal 100. However, the position search system may also send by mail the image information, etc. pointing the position of the vending machine 400 on the map information or may prompt the user to browse the Web page.

Moreover, for instance, the following process can be exemplified as a process in a case where the vending machine 400 responds to the position information measuring radio waves in the position search system.

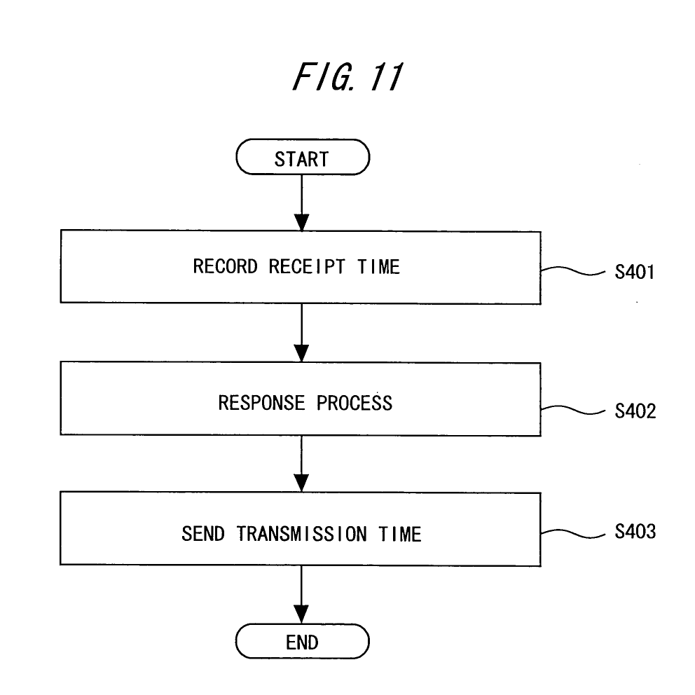

FIG. 11 is a flowchart of one example of a response process of the vending machine 400 to the position information measuring radio waves in the position search system. To begin with, the vending machine 400, when receiving the position information measuring radio waves transmitted from the measuring-side mobile terminals 300, records a receipt time (step 401 in FIG. 11, which will hereinafter be abbreviated such as S401). Then, the vending machine 400 executes the response process to the position information measuring radio waves (S402).

The vending machine 400, when transmitting response radio waves to the position information measuring radio waves, records a transmission time, and transmits the receipt time and the transmission time to the measuring-side mobile terminals 300 (S403). At this time, the vending machine 400 calculates a response time expended in the vending machine 400 from the receipt time and the transmission time, and may transmit the response time to the measuring-side mobile terminals 300. Through the processes given above, in the position search system, the distances between the measuring-side mobile terminals 300 and the vending machine 400 can be calculated based on a transmission time of the transmitted radio waves by excluding a delay time due to the processing in the vending machine 400.

Further, the position search system presumes the latitude and the longitude as the information indicating the geographical position information of the vending machine 400. The present invention is not, however, limited to the latitude and the longitude. For example, the position information of the search object may be obtained by a coordinates system in which the position of the base station serves as an original thereof.

Moreover, the position search system may also be provided with a function (e.g., a menu, etc.) for setting a range of the search object, when the request-side mobile terminal 100 sends the search request to the measuring-side mobile terminals 300 (described below). Then, the electric power for transmission may be controlled corresponding to a size of the search object range in accordance with this setting.

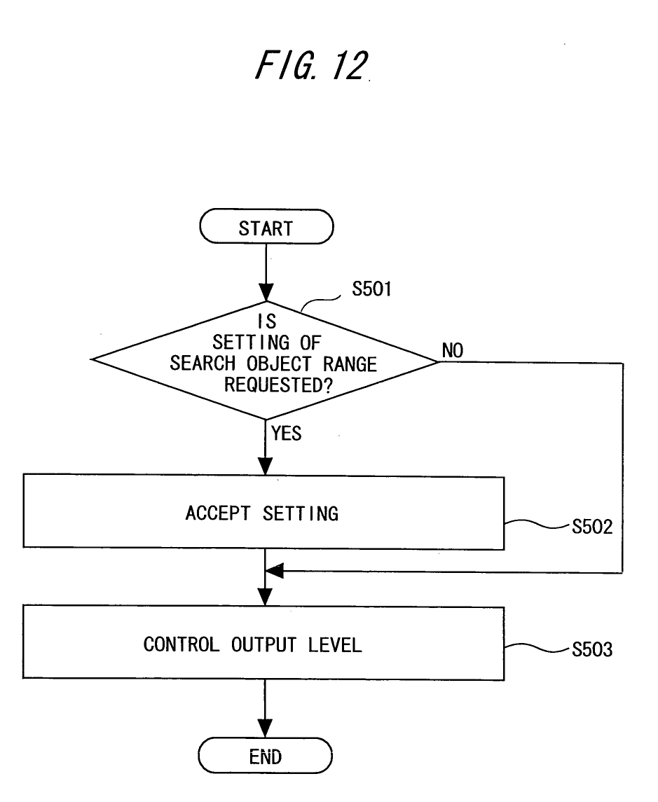

FIG. 12 is a flowchart when the request-side mobile terminal 100 sets the search object range for the measuring-side mobile terminals 300 in the position search system. At first, the request-side mobile terminal 100 judges whether the user makes a request for setting the search object range or not (step 501 in FIG. 12, which will hereinafter be abbreviated such as S501). At this time, if the user does not make the request for setting the search object range, the request-side mobile terminal 100 advances the control to step 503. In this case, the request-side mobile terminal 100 controls an output of the electromagnetic waves carrying the search request to a predetermined output.

In the case of having made the request for setting the search object range, the request-side mobile terminal 100 accepts the setting of the transmission range of the search object from the user (S502).

The request-side mobile terminal 100 controls the electromagnetic waves carrying the search request to a predetermined receipt electric power level in the accepted transmission range of the search object (S503). This may be calculated from a radiation electric power characteristic and a directivity of the unillustrated antenna.

Through these processes, in the position search system, it is feasible to send the search request at the predetermined receipt electric power level to the measuring terminals existing in the range matching with the request of the user. As a result, in the position search system, the search area peripheral to the request-side mobile terminal 100 can be narrowed down.

The present invention may be embodied in other specific forms without departing from the spirit or essential characteristics thereof. The present invention embodiment is therefore to be considered in all respects as illustrative and not respective, the scope of the invention being indicated by the appended claims rather than by the foregoing description and all changes which come within the meaning and range of equivalency of the claims is therefore intended to be embraced therein.

1. A measuring apparatus cooperating with a service device for providing position information to a request apparatus requesting a position of a search object, comprising:
a unit accepting from the request apparatus a search request for searching the position of the search object;
a unit calculating a distance between the measuring apparatus and the search object;
a unit acquiring present position information of the measuring apparatus; and
a unit transmitting the present position information and the distance information to the service device.

2. A measuring apparatus according to claim 1, further comprising:
a unit transmitting radio waves receivable by the search object; and
a unit receiving a response to the radio waves from the search object.

3. A measuring apparatus according to claim 1, wherein the search request contains information capable of specifying the request apparatus, and
the unit transmitting the present position information and the distance information together with the specifiable information to the service device.

4. A service device for providing position information to a request apparatus requesting the position information of a search object, comprising:
a unit receiving, from a measuring apparatus for measuring a position of the search object, present position information of the measuring apparatus and information about a distance between the measuring apparatus making the measurement and the search object; and
a unit transmitting to the request apparatus the position information of the search object that has been calculated based on the present position information and the information about the distance to the search object.

5. A request apparatus provided with position information of a search object through a system including a service device for providing the position information of the search object and measuring apparatuses for reporting distances to the search object to the service device, comprising:
a unit transmitting a search request for the position information of the search object to the measuring apparatuses existing in the periphery of the self-apparatus; and
a unit receiving via the service device the position information of the search object that is based on the reports given from the measuring apparatuses.

6. A request apparatus according to claim 5, wherein the search request contains information capable of specifying the individual request apparatus and information for designating the search object, and
the receiving unit receives the position information in accordance with the specifiable information.

7. A request apparatus according to claim 5, further comprising unit receiving setting of a search object range in the periphery of the self-apparatus,
wherein the transmitting unit includes transmission gain control unit controlling electromagnetic waves carrying the search request at a predetermined receipt electric power level in the search object range.

8. A method executed by a apparatus cooperating with a service device for providing position information to a request apparatus requesting a position of a search object, comprising:
accepting from the request apparatus a search request for searching the position of the search object;
transmitting radio waves receivable by the search object;
receiving a response to the radio waves from the search object;
calculating a distance between the apparatus and the search object from the response received;
acquiring present position information of the apparatus; and
transmitting the present position information and the distance information to the service device.

9. A position information measuring method according to claim 8, wherein the search request contains information capable of specifying the request apparatus, and
transmitting the present position information and the distance information together with the specifiable information to the service device.

10. A method executed by a service device for providing position information to a request apparatus requesting the position information of a search object, comprising:
receiving, from a measuring apparatus for measuring a position of the search object, present position information of the measuring apparatus and information about a distance between the measuring apparatus making the measurement and the search object; and
transmitting to the request apparatus the position information of the search object that has been calculated based on the present position information and the information about the distance to the search object.

11. A method executed by a apparatus provided with position information of a search object through a system including a service device for providing the position information of the search object and measuring apparatuses for reporting distances to the search object to the service device, comprising:
transmitting a search request for the position information of the search object to the measuring apparatuses existing in the periphery of the self-apparatus; and
receiving via the service device the position information of the search object that is based on the reports given from the measuring apparatuses.

12. A position information requesting method according to claim 11, wherein the search request contains information capable of specifying the individual request apparatus and information for designating the search object, and
receiving the position information in accordance with the specifiable information.

13. A position information requesting method according to claim 11, further comprising receiving setting of a search object range in the periphery of the self-apparatus,
controlling electromagnetic waves carrying the search request at a predetermined receipt electric power level in the search object range.

14. A storage medium that stored an executable-by-computer position information measuring program for making a apparatus cooperating with a service device for providing position information to a request apparatus requesting a position of a search object, the program execute:
accepting from the request apparatus a search request for searching the position of the search object;
transmitting radio waves receivable by the search object;
receiving a response to the radio waves from the search object;
calculating a distance between the apparatus and the search object from the response received;
acquiring present position information of the apparatus; and
transmitting the present position information and the distance information to the service device.

15. A storage medium that stored a position information measuring program according to claim 13, wherein the search request contains information capable of specifying the request apparatus, and
transmitting the present position information and the distance information together with the specifiable information to the service device.

16. A storage medium that stored a program for making a computer for providing position information to a request apparatus requesting the position information of a search object, the program execute:
receiving, from a measuring apparatus for measuring a position of the search object, present position information of the measuring apparatus and information about a distance between the measuring apparatus making the measurement and the search object; and
transmitting to the request apparatus the position information of the search object that has been calculated based on the present position information and the information about the distance to the search object.

17. A storage medium that stored an executable-by-computer position information requesting program for making an apparatus provided with position information of a search object through a system including a service device for providing the position information of the search object and measuring apparatuses for reporting distances to the search object to the service device, the program execute:
transmitting a search request for the position information of the search object to the measuring apparatuses existing in the periphery of the self-apparatus; and
receiving via the service device the position information of the search object that is based on the reports given from the measuring apparatuses.

18. A storage medium that stored a position information requesting program according to claim 17, wherein the search request contains information capable of specifying the individual request apparatus and information for designating the search object, and
receiving the position information in accordance with the specifiable information.

19. A storage medium that stored a position information requesting program according to claim 17, wherein the apparatus is made to further execute receiving setting of a search object range in the periphery of the self-apparatus,
transmitting a transmission gain control controlling electromagnetic waves carrying the search request at a predetermined receipt electric power level in the search object range.
